(19) United States
(12) Patent Application Publication
(10) Pub. No.: US 2006/0020797 A1
(43) Pub. Date: Jan. 26, 2006

(54) Method for verifying a secure association between devices

(76) Inventors: Kan Zhang, Palo Alto, CA (US); Timothy P.J.G Kindberg, Bristol (GB); Seunghyun Im, Charlotte, NC (US)

Correspondence Address: HEWLETT-PACKARD COMPANY;Intellectual Property Administration, P.O. Box 272400, Fort Collins, CO, 80527-2400, US

(21) Appl. No.: 10/887,957

(22) Filed: Jul. 8, 2004

(51) Int. Cl. H04L 9/00

(52) U.S. Cl. 713/169

(57) ABSTRACT

There is disclosed a method for verifying that a secure association has been formed between a first device and a second device by comparing a secret key of the first device to a secret key of the second device. The method includes transforming the secret key of the first device and the second device using a predetermined transformation. A user verifiable comparison of the transformed secret key of the first and second devices is performed and if the transformed secret keys of the first and second devices match the association is verified as being secure. The method can include representing the transformed secret keys of the first device and the second device in a user perceptible manner.

### FIELD OF THE INVENTION

The present invention relates generally to communications between devices and more particularly to a method for verifying a secure association between two devices.

### BACKGROUND OF THE INVENTION

One of the goals of modern computing is to provide people with ubiquitous computing environments. In these computing environments it is necessary to allow devices to become spontaneously associated and interoperable with other devices.

An association is made between two (or more) devices when each device possesses data (e.g. another device's network address) that allows the devices to communicate with each other. An association is considered to be secure if a secret encryption key has been established and is known only to the associated devices.

Due to the ad-hoc nature of such spontaneous associations the connections formed between devices will generally take place over wireless communication links. However, in some situations wired connections, or combinations of wired and wireless connections will also be used to make spontaneous associations between devices.

The creation of spontaneous associations between devices raises security concerns for users of the devices. In the first instance there is the need for suitable key-exchange protocols to establish secure associations between devices. However even once a key-exchange protocol has been run it is difficult, if not impossible, for the user(s) of the associated devices to verify that the key-exchange protocol has run successfully and that the association is truly secure.

### SUMMARY OF THE INVENTION

In broad concept the present invention provides a method of verifying that a secure association has been formed by comparing the secret keys of the associated devices.

According to a first aspect of the present invention there is provided a method for verifying that a secure association has been formed between a first device and a second device by comparing a secret key of the first device to a secret key of the second device. The method includes transforming the secret key of the first device using a predetermined transformation and transforming secret key of the second device using said predetermined transformation.

### BRIEF DESCRIPTION OF THE DRAWINGS

Embodiments of the present invention will now be described by way of non-limiting example only, with reference to the accompanying drawings, in which:

FIG. 1 shows a schematic representation of an association formed between two devices in accordance with an embodiment of the present invention;

FIG. 2 shows a flow chart depicting a method for verifying that a secure association has been made between two devices in accordance with an embodiment of the present invention; and

FIG. 3 shows a schematic diagram showing the situation in which three devices have become spontaneously associated with each other, in which a method as set out in FIG. 2 can be used to verify that the association is secure in accordance with an embodiment of the present invention.

### DETAILED DESCRIPTION OF THE EMBODIMENTS

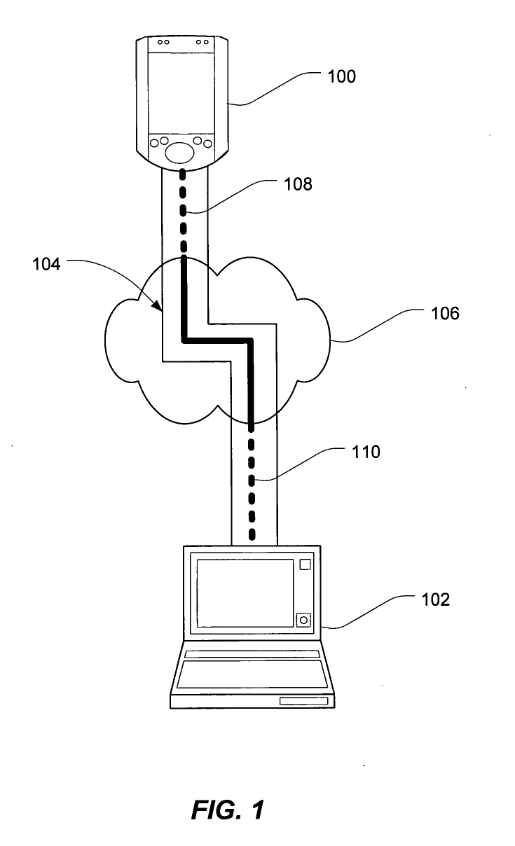

FIG. 1 shows a schematic diagram representing an association that has been formed between two devices in which a method according to an embodiment can be used to verify the security of the association. FIG. 1 shows two computer devices, namely a personal digital assistant (PDA) 100 and a notebook computer 102 which have formed an ad-hoc association 104 with each other.

In the present example, the PDA 100 and the notebook computer 102 are connected to a communications network 106 via wireless communications links 108 and 110 respectively. As will be appreciated by those skilled in the art the association between the devices 100 and 102 may alternatively be formed by a direct wireless or wired communications link or via any combination of wired and wireless computer networks. The wireless links 108 and 110 may operate according to any known wireless standard, including but not limited to the IEEE 802.11 or Bluetooth.

In the disclosed embodiment the encryption of the communications link can be implemented using a key exchange protocol, such as the Diffie-Hellman key exchange protocol, described in Whitfield Diffie and Martin Hellman, “New Directions in Cryptography”, IEEE Transactions on Information Theory, v. IT-22, n.6, November 1976, the contents of which are incorporated herein by reference.

Other key exchange protocols may also be used so long as they have the property that a man-in-the-middle is unable to use the key exchange protocol to set up the same secret key with the two different parties.

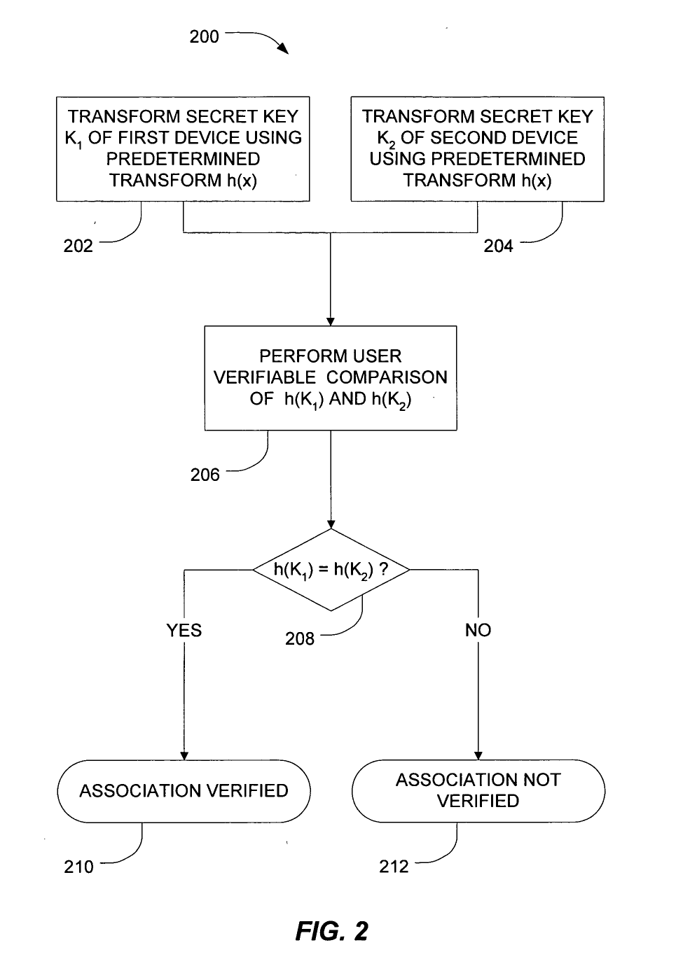

FIG. 2A shows a flow chart depicting a process 200 for verifying that the key exchange protocol has been executed properly. More particularly the process 200 enables the detection of a man-in-the-middle attack in which he has managed to exchange a different key with each of the devices without being detected.

In initial steps 202 and 204 the associated devices, termed the first device and the second device, may correspond to the devices 100 and 102 of FIG. 1. The first device and the second device each have a respective unverified secret keys K₁ and K₂ that have been generated according to a key exchange protocol as described above.

In step 202 the first device uses a predetermined function h(x) to generate a substantially irreversible transformation of its secret key, h(K₁). In an embodiment, the function h(x) is a one-way function, which has the property that given h(x) it is computationally infeasible to compute x. Suitable one way functions include the secure hash functions MD5 and SHA-1.

Choosing the transformation so as to minimise the length of the transformed encryption keys can be advantageous as it decreases the likelihood that the user will make a mistake in their comparison. However, the shorter the transformed encryption keys are the more likely it is that a man-in-middle attacker will guess the correct value of the transformed secret key of one of the devices.

Thus in one embodiment, a relatively short hash value can be used to represent the secret encryption keys of the parties, rather than using standard length hash values.

In step 204 the second device uses h(x) to generate h(K₂) from K₂.

In the next step 206 a user verifiable comparison of h(K₁) and h(K₂) is made. In an embodiment, the comparison will be performed directly by a user of one or both of the first or second devices.

The one-way nature of the selected function h(x) means the users of the first and second devices can safely make the representations of their respective h(K_{S}) public without being concerned that any third party can determine their secret key, and hence the comparison can be made without secrecy.

In an embodiment each device generates a humanly perceptible representation of its respective equivalently transformed secret key that can be compared to the transformed secret key of each of the other associated device. The humanly perceptible representation of the devices' transformed secret keys can take various forms as will be described below.

In some instances only one of the associated devices will have a user that will be able to make a comparison between the transformed secret keys of the associated devices, for example an association may be made between a notebook computer and a printer. In such a case, where the printer does not have a designated user, but is a public device, the user of the notebook computer will verify that h(Kₚᵣᵢₙₜₑᵣ)=h(K_{notebook}), where h(Kₚᵣᵢₙₜₑᵣ) and h(K_{notebook}) are the transformed secret keys of the printer and notebook respectively.

In an embodiment, the printer displays a visible representation of h(Kₚᵣᵢₙₜₑᵣ) on a display unit of the printer that is viewable by the user of the notebook computer. The notebook is configured to show a visual representation of h(K_{notebook}) to allow the user to make a comparison with the displayed h(Kₚᵣᵢₙₜₑᵣ).

As mentioned above, the comparison of the transformed secret keys in the above-described embodiment is performed by providing the user with a humanly perceptible and comparable indication of the associated devices' transformed secret keys. It should be noted that the comparison of the devices' transformed secret keys may be performed visually or aurally, or using a combination of visual and audio indications of the transformed secret keys.

As will be appreciated there are many types of humanly perceptible representation that may be used to allow comparison of the transformed secret keys of associated devices. A number of exemplary types of representation will now be described. It should be understood that the present invention extends to the use of all forms representation of the transformed secret keys of associated devices that can be perceived by a user of one of the associated devices.

In a first example, a device can be configured to display an associated transformed secret key (or an encoded version thereof) on a screen or display of the device, to allow comparison of its h(K_{S}) to the h(K_{S}) of other devices. The encoding can take the form of a numerical representation of the transformed secret key or a graphical representation thereof. The graphical representation can take a wide variety of forms including but not limited to, a “bar code” or one or more shapes, icons or glyphs in which the size, configuration, colour, pattern or ornamentation or other parameters of which are determined by the transformed secret key value.

In a second example, a device can be configured to display its transformed secret key (or an encoded version thereof) by the selective illumination of an indicator light associated with the device. In an embodiment, the indicator light is turned on and off in accordance with a binary representation of its transformed secret key.

In a device with at least two different indicator lights, the lights can be illuminated to represent different digit values in a numerical representation of the transformed secret key, e.g. each digit in the numerical string representing the transformed secret key can be represented by illumination of a predetermined pattern of indicator lights. In a binary representation, a first light may be illuminated if a “1” is to be displayed and a second light may be illuminated if a “0” is to be displayed.

In a further example the transformed secret key of a device can be presented to the user as an audible signal. The audible signal can be generated by an in-built speaker or a sound reproduction device associated with the device, such as an external speaker.

In a first version of this embodiment the digits of a numerical representation of the transformed secret key of a device can be played as a sequence of sounds, with different frequency sounds (or notes) being used to represent to the numerical values of each digit in the numerical representation.

The transformed secret keys may alternatively be presented to the user(s) in a tangible form. For example the associated devices can be caused to vibrate to communicate their respective transformed secret keys to the user(s). If the devices vibrate in concert then the transformed secret keys can be considered to match.

In use the user of either the first or second device can directly compare the humanly perceptible representations of the transformed secret keys of two devices to determine whether they match. Preferably at least one of the first or second devices is mobile and therefore allows a side-by-side comparison of the similarly encoded and represented transformed secret keys to be made by a user.

In an alternative embodiment an automated comparison of h(K₁) and h(K₂) may be made so long the following conditions are met:
the comparison is made using a communications channel or comparison device that does not rely on the unverified association; and
the comparison is humanly verifiable.

For example a trusted third device connected securely to both of the associated devices can perform the comparison of h(K₁) and h(K₂). If the user of one (or both) of the devices wishes to verify the outcome of the comparison the transformed secret key of the other device can be communicated to his or her device via the secure communications route via the third device.

Returning now to the flowchart of FIG. 2; Next, in step 208, the user of one or both of the associated devices determines if the security of the association is verified.

If the transformed secret key of the first device and the transformed secret key of the second device are found to be identical to each other, that is h(K₁)=h(K₂), the user(s) can be satisfied that a secure association has been formed between the devices, and the association is verified in step 210.

Alternatively, if the user(s) of either of the devices finds that the transformed secret key of the first device does not match the transformed secret key of the second device, that is h(K₁)≠h(K₂), the security of the association is not verified and the process ends at step 212. In this situation the user(s) can terminate the association or operate the association in an unsecured manner.

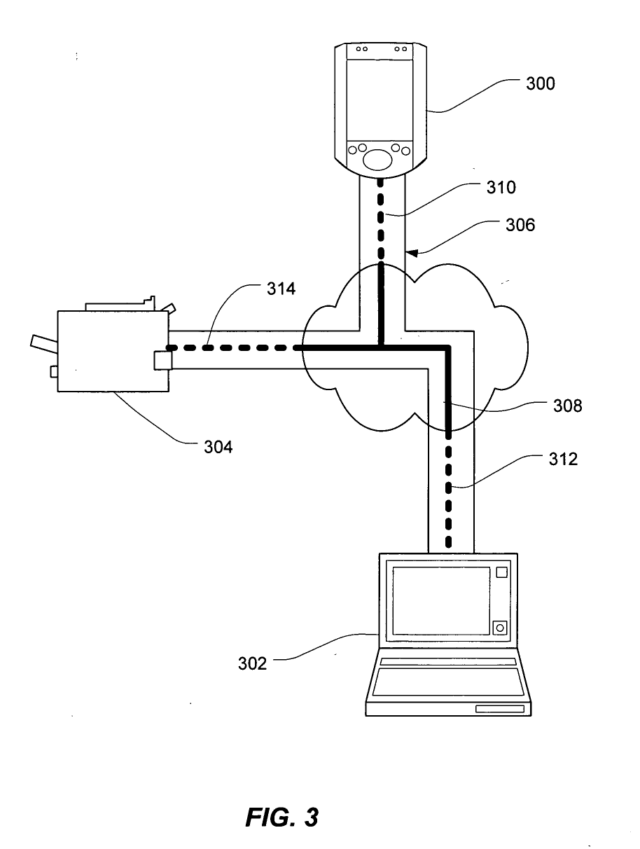

FIG. 3 shows a schematic diagram showing the situation in which three devices have become spontaneously associated with each other. In this scenario the devices are a PDA 300, a notebook computer 302 and a printer 304. The association 306 enables communication between all three devices 300, 302 and 304. Each of the devices 300, 302 and 304 are connected to a wired communications network 308 via respective wireless communications links 310, 312 and 314.

As described in connection with FIG. 1 the wireless links 310, 312 and 314 may operate according to any known wireless standard, including but not limited to the IEEE 802.11 or Bluetooth standards.

The creation of a spontaneous association with three (or more) devices operates in a similar manner to the creation of an association between two devices. The initial step is setting up the association using a key exchange protocol. The key exchange protocol can be either a protocol that generates a group key or generates pair-wise keys for securing communication between pairs of devices in the association. Once the key exchange protocol has been run the verification process can be executed.

In the case in which pair-wise keys are generated to encrypt communications between pairs of devices in the three-way association, a verification procedure identical to the one described above can be performed to validate that each key exchange has been performed successfully. Thus in the present example, each device 300, 302 and 304 will take part in the protocol twice, once with each of the other two devices.

In cases in which a key exchange protocol that generates a group key is used the comparison method is simplified since the secret key K_{S}, and consequently the transformed secret key h(K_{S}) for each device should be the same. In this case if N devices are associated the verification method need only be run between N−1 discrete pairs of devices to ensure that any device in the association can securely communicate with any other device in the association.

It will be understood that the invention disclosed and defined herein extends to all alternative combinations of two or more of the individual features mentioned or evident from the text or drawings. All of these different combinations constitute various alternative aspects of the invention.

The foregoing describes embodiments of the present invention and modifications, obvious to those skilled in the art can be made thereto, without departing from the scope of the present invention.

1. A method for verifying that a secure association has been formed between a first device and a second device by comparing a secret key of the first device to a secret key of the second device; the method including:
transforming the secret key of the first device using a predetermined transformation;
transforming secret key of the second device using said predetermined transformation;
performing a user verifiable comparison of the transformed secret key of the first and second devices; and
verifying that the association is secure if the transformed secret keys of the first and second devices match.

2. The method of claim 1 which includes:
representing the transformed secret key of the first device in a user perceptible manner; and
representing the transformed secret keys of the second device in a user perceptible manner.

3. The method of claim 2 in which the predetermined transformation is a one-way function.

4. The method of claim 3 in which the one-way function is a hash function.

5. The method of claim 2 in which the transformed secret keys are represented in a visible form.

6. The method of claim 2 in which the transformed secret keys are represented in an audible form.

7. A method of forming a verified secure association between a first device and a second device; including
forming an association between the first device and a second device;
securing the association using a key exchange protocol to generate and distribute a secret encryption key to each of the first and second devices,
verifying that the association is secure by performing a user verifiable comparison of a representation of the secret key of the first device with a representation of the secret key of the second device.

8. The method of claim 7 including
transforming the secret key of the first device using a predetermined transformation;
representing the transformed secret key of the first device in a user perceptible manner;
transforming the secret key of the second device using said predetermined transformation; and
representing the transformed secret keys of the second device in a user perceptible manner to allow said user verifiable comparison to be made.

9. The method of claim 8 in which the predetermined transformation is a one-way function.

10. The method of claim 9 in which the one-way function is a hash function.

11. The method of claim 10 in which the transformed secret keys of the first and second devices are represented in a visible form.

12. The method of claim 10 in which the transformed secret keys of the first and second devices are represented to be audible to a user.

13. A computer network comprising an association formed between a first computer device and a second computer device, wherein security of the association formed between the first and second device is checked by:
transforming the secret key of the first device using a predetermined transformation;
transforming secret key of the second device using said predetermined transformation; and
performing a user verifiable comparison of the transformed secret key of the first and second devices.

14. The computer network of claim 13 further comprising, verifying that the association is secure if the transformed secret keys of the first and second devices match.

15. The computer network of claim 13 further comprising;
representing the transformed secret key of the first device in a user perceptible manner; and
representing the transformed secret keys of the second device in a user perceptible manner.

16. The computer network of claim 13 wherein the predetermined transformation is a one-way function.

17. The computer network of claim 16 wherein the one-way function is a hash function.

18. The computer network of claim 13 in which the association is formed at least in part using a wireless communications link.

19. A method for verifying that a secure association has been formed between a first device and a second device by comparing a secret key of the first device to a secret key of the second device; the method comprising:
transforming the secret key of the first device using a predetermined transformation;
performing a user verifiable comparison of the transformed secret key of the first with a transformation of the secret key of the second device; and
verifying that the association is secure if the transformed secret keys of the first and second devices match.

20. The method of claim 19 which further comprises representing the transformed secret key of the first device in a user perceptible manner for comparison with a user perceptible representation of the transformed secret key of the second device.

21. The method of claim 19 wherein the predetermined transformation is a one-way function.

22. The method of claim 21 in which the one-way function is a hash function.

23. A computer program configured to be run on a networkable computer device said program being configured to enable the security of an association formed with a second computer device to be checked; the computer program causing the computer device to:
transform the secret key of the first device using a predetermined transformation;
enable a user verifiable comparison of the transformed secret key of the first with a transformation of the secret key of the second device to be performed to enable the security of the association to be verified if the transformed secret keys of the first and second devices match.

24. The computer program of claim 23 which is further configured to cause the computer to generate a user perceptible representation of the transformed secret key of the first device.

25. The computer program of claim 23 wherein the predetermined transformation is a one-way function.

26. The computer program of claim 25 wherein the one-way function is a hash function.

27. The computer program of claim 24 wherein the user perceptible representation is a visual representation.

28. The computer program of claim 24 wherein the user perceptible representation is a audio representation.

29. The computer program of claim 24 wherein the user perceptible representation is a tactile representation.

30. A computer device able to form a network association with a second computer device secured using a key-exchange protocol, wherein the computer device is configured to enable the security of a particular association formed with a second computer device to be verified by: p1 transforming the secret key of the first device using a predetermined transformation; and
enabling a user verifiable comparison of the transformed secret key of the first with a transformation of a secret key of the second device, wherein the association is verified as secure if the transformed secret keys of the first and second devices match.

31. The computer device of claim 30 further configured to generate a user perceptible representation of the transformed secret key of the first device.

32. The computer device of claim 30 wherein the predetermined transformation is a one-way function.

33. The computer device of claim 32 wherein the one-way function is a hash function.

34. The computer device of claim 31 wherein the user perceptible representation is a visual representation.

35. The computer device of claim 31 wherein the user perceptible representation is a audio representation.

36. The computer program of claim 24 wherein the user perceptible representation is a tactile representation.
